(19) United States
(12) Patent Application Publication
(10) Pub. No.: US 2004/0019658 A1
(43) Pub. Date: Jan. 29, 2004

(54) Metadata retrieval protocols and namespace identifiers

(75) Inventors: Daniel Plastina, Sammamish, WA (US); John Wesley Terrell, Bothell, WA (US); Jason E. D. McCartney, Redmond, WA (US); Keith Maurice Toussaint, Seattle, WA (US); David W. H. Hostetter, Redmond, WA (US); Thomas Brian Springer JR., Redmond, WA (US); Aaron P. Starkey, Seattle, WA (US)

Correspondence Address: SENNIGER POWERS LEAVITT AND ROEDEL, ONE METROPOLITAN SQUARE, 16TH FLOOR, ST LOUIS, MO, 63102, US

(73) Assignee: Microsoft Corporation

(21) Appl. No.: 10/623,235

(22) Filed: Jul. 18, 2003

Related U.S. Application Data
(63) Continuation-in-part of application No. 09/817,808, filed on Mar. 26, 2001.

(51) Int. Cl. G06F 15/16

(52) U.S. Cl. 709/217

(57) ABSTRACT

Obtaining metadata for media content. Software according to the invention requests the metadata via a metadata query data structure (MDQ) such as a uniform resource locator and receives metadata in response via a metadata return data structure (MDR). The invention includes namespace identifiers such as WMContentID, WMCollectionID, and WMCollectionGroupID for instance-specific associations between media content and metadata. The invention also includes namespace identifiers such as WMPrimaryClassID and WMSecondaryClassID to classify the media content.

### CROSS-REFERENCE TO RELATED APPLICATION

This application is a continuation-in-part of co-pending U.S. patent application Ser. No. 09/817,808, filed Mar. 26, 2001, entitled “METHODS AND SYSTEMS FOR PROCESSING MEDIA CONTENT,” which is hereby incorporated herein by reference in its entirety for all purposes.

### TECHNICAL FIELD

Embodiments of the present invention relate to the field of metadata for media content. In particular, embodiments of this invention relate to metadata retrieval protocols for obtaining metadata for media content.

### BACKGROUND OF THE INVENTION

Due to recent advances in technology, computer users are now able to enjoy many features that provide an improved user experience, such as playing various media and multimedia content on their personal or laptop computers. For example, most computers today are able to play compact discs (CDs) so users can listen to their favorite musical artists while working on their computers. Many computers are also equipped with digital versatile disc (DVD) drives enabling users to watch movies.

In some multimedia environments, a computer has access to a computer-readable medium storing compressed media files such as Moving Picture Experts Group audio layer-3 (MP3) files and WINDOWS MEDIA technologies audio (WMA) and video files. The computer typically organizes the media files into playlists when the compressed media files are played on the computer. The files may be organized according to metadata associated with the media content. Metadata for a digital media file such as an audio file includes general information pertaining to the media file itself. This information is typically stored within the file. For example, an audio file may have metadata tags for the song title, song artist, album title, and a rating. For example, in the case of audio media files, the files may be organized by album, artist, genre, date, or some user-specified selection and ordering. A user easily navigates through this organization using menus and graphical displays to render the desired media files.

However, some media files lack metadata or have metadata that needs to be updated. The organization of such media files without sufficient metadata is limited. There is a need for obtaining or computing relevant metadata for such media files. For example, there is a need for metadata retrieval protocols to fetch metadata from a metadata source (e.g., a server).

The data interchange flow in existing systems includes identifying items of audio content from the media player on an album basis via a table of contents (TOC) value obtained from the physical medium storing the audio content. These existing systems include metadata providers that serve metadata. However, these systems are limited and often inaccurate in that they rely on the TOC value to obtain metadata. Further, these systems often use a serialized form of authentication that permits each client device to be trusted, but also permits tracking of a user's listening habits because the user would become a well known registered user of the system. The existing systems lack a means to obscure and protect the metadata to permit continued anonymity of the user.

Accordingly, an improved system for obtaining metadata for media content is desired to address one or more of these and other disadvantages.

### SUMMARY OF THE INVENTION

Embodiments of the invention include obtaining metadata for media content. In an embodiment, the invention includes requesting metadata for the media content file from a metadata provider via a request data structure. The request data structure includes a request type identifier defining a type for the computer-readable medium, a request identifier, and one or more metadata elements stored with the media content file. The invention further includes receiving a return data structure from the metadata provider. The return data structure includes a return type identifier defining the type for the computer-readable medium, the request identifier, and return metadata corresponding to the requested metadata.

The invention also includes identifiers for metadata fetching and/or computation. The values of some of the identifiers directly map metadata to an item or instance of media content. In one embodiment, such identifiers include WMContentID, WMCollectionID, and WMCollectionGroupID. The value of each of the identifiers includes a globally unique identifier (GUIDs).

The values of other identifiers in the invention specify a class and type associated with the media content. In one embodiment, such identifiers include WMPrimaryClassID and WMSecondaryClassID. The value of each of the identifiers includes a globally unique identifier (GUIDs). Each GUID value is defined to imply a particular media class or type. The invention automatic classifies the media file by generating one or more of the class/type identifiers by using other available identifiers (e.g., the instance identifiers). The identifiers used in the invention enable fast and automatic classification of media content without user intervention in media applications such as a media player. The identifiers are extensible after a product is released and are independent of the software rendering the media file.

Software according to the invention matches metadata for any type of media that the media player recognizes (e.g., MP3 files). The invention improves the user experience and increases the range of metadata available to users.

In accordance with one aspect of the invention, a method obtains metadata for a media content file storing media content. The media content file is stored on a computer-readable medium. The method includes requesting metadata for the media content file from a metadata provider via a request data structure. The request data structure includes a request type identifier that defines a type for the computer-readable medium, a request identifier, and one or more metadata elements stored with the media content file. The method also includes receiving a return data structure from the metadata provider. The return data structure stores a return type identifier defining the type for the computer-readable medium, the request identifier, and return metadata corresponding to the requested metadata.

In accordance with another aspect of the invention, a method includes determining an identifier value and associating the determined identifier value with media content. The method also includes assigning the determined identifier value to one or more of the following fields: WMContentID, WMCollectionID, WMCollectionGroupID, WMPrimaryClassID, and WMSecondaryClassID. The method also includes storing the identifier value and assigned fields with the media content.

In accordance with yet another aspect of the invention, one or more computer-readable media have computer-executable components for obtaining metadata for a media content file storing media content. The media content file is stored on a computer-readable medium. The components include a query component for requesting metadata for the media content file from a metadata provider via a request data structure. The request data structure includes a request type identifier defining a type for the computer-readable medium, a request identifier, and one or more metadata elements stored with the media content file. The components also include an interface component for receiving a return data structure from the metadata provider in response to the request sent by the query component. The return data structure stores a return type identifier defining the type for the computer-readable medium, the request identifier, and return metadata corresponding to the requested metadata.

In accordance with still another aspect of the invention, a media player includes computer-executable instructions for obtaining metadata for a media content file storing media content. The media content file is stored on a computer-readable medium. The instructions include requesting metadata for the media content file from a metadata provider via a request data structure. The request data structure includes a request type identifier defining a type for the computer-readable medium, a request identifier, and one or more metadata elements stored with the media content file. The request data structure includes receiving a return data structure from the metadata provider. The return data structure stores a return type identifier defining the type for the computer-readable medium, the request identifier, and return metadata corresponding to the requested metadata.

In accordance with another aspect of the invention, a computer-readable medium stores a data structure representing a request for metadata. The data structure is transmitted by a first computing device to a second computing device to request metadata for media content. The data structure includes a request type identifier defining a type for a destination computer-readable medium storing the media content, a request identifier, and one or more metadata elements stored with the media content.

In accordance with yet another aspect of the invention, a computer-readable medium stores a data structure sent from a first computing device to a second computing device in response to a request for metadata sent by the second computing device. The data structure includes a return type identifier defining a type for a destination computer-readable medium storing the media content, a request identifier, and return metadata corresponding to the requested metadata.

In accordance with still another aspect of the invention, a computer-readable medium stores a data structure representing a namespace for identifying media content. The data structure includes a first field storing a content identifier value, a second field storing a collection identifier value, and a third field storing a group identifier value. The first field has a label of WMContentID, the second field has a label of WMCollectionID, and the third field has a label of WMCollectionGroupID.

In accordance with another aspect of the invention, a computer-readable medium stores a data structure representing a namespace for classifying media content. The data structure includes a first field storing a primary identifier value and a second field storing a secondary identifier value. The first field has a label of WMPrimaryClassID and the second field has a label of WMSecondaryClassID.

In accordance with yet another aspect of the invention, a computer-readable file stores media content. The computer-readable file also stores one or more of the following identifiers characterizing the media content: WMContentID, WMCollectionID, WMCollectionGroupID, WMPrimaryClassID, and WMSecondaryClassID. The computer-readable file also stores an identifier value associated with each of the one or more identifiers.

In accordance with still another aspect of the invention, a method obtains metadata for media content. The media content is stored on a computer-readable medium. The method includes formulating a network address with a query string parameter. The query string parameter includes an identifier and a value associated therewith. The identifier or a portion thereof includes the text string WMID. The associated value corresponds to the media content.

In accordance with another aspect of the invention, a method obtains metadata for media content. The media content is stored on a computer-readable medium. The method includes formulating a network address with a query string parameter. The query string parameter includes an identifier and a value associated therewith. The identifier or a portion thereof includes the text string CD. The associated value corresponds to the media content.

In accordance with yet another aspect of the invention, a method processes media content. The method includes receiving a request for metadata associated with the media content. The request includes one or more metadata elements. The method also includes searching for the requested metadata in a database based on the received metadata elements. The method also includes ranking the results of the searching. The method also includes correlating the ranked results with a table to identify the requested metadata.

Alternatively, the invention may comprise various other methods and apparatuses.

Other features will be in part apparent and in part pointed out hereinafter.

### BRIEF DESCRIPTION OF THE DRAWINGS

FIG. 1 is a block diagram illustrating one example of a suitable media environment in which the invention may be implemented.

FIG. 2 is an exemplary flow chart illustrating a communication protocol for requesting metadata according to the invention.

FIG. 3 is an exemplary flow chart illustrating a specific implementation of the communication protocol for requesting metadata according to the invention.

FIG. 4 is an exemplary flow chart illustrating the creation of new identifier values for the namespace identifiers.

FIG. 5 is an exemplary flow chart illustrating operation of text matching software.

FIG. 6 is an exemplary block diagram illustrating a metadata query data structure.

FIG. 7 is an exemplary block diagram illustrating a metadata return data structure.

FIG. 8 is an exemplary block diagram illustrating a content/collection/group namespace data structure.

FIG. 9 is an exemplary block diagram illustrating a media class identifier namespace data structure.

FIG. 10 is a block diagram illustrating one example of a suitable computing system environment in which the invention may be implemented.

Corresponding reference characters indicate corresponding parts throughout the drawings.

### DETAILED DESCRIPTION OF THE INVENTION

In one embodiment, the invention enables a bidirectional conversation between two or more computers about the same media content file. A computer with a metadata-lacking media file sends enough information about the media file to another computer acting as a metadata provider to permit the other computer to identify metadata associated with the media file. For example, in addition to or in lieu of providing a table of contents value to a metadata provider to identify a media content file, a media player according to the invention provides various metadata elements (e.g., album title or artist name) that may be available in the media file.

The invention may be described in terms of a client (e.g., media player software) requesting and receiving metadata from a server (e.g., the metadata provider). However, it is contemplated by the inventors that the invention is operable in other network systems. That is, the invention is not limited to a client/server network system. For example, the invention may be applicable in a peer-to-peer network system.

Media Environment

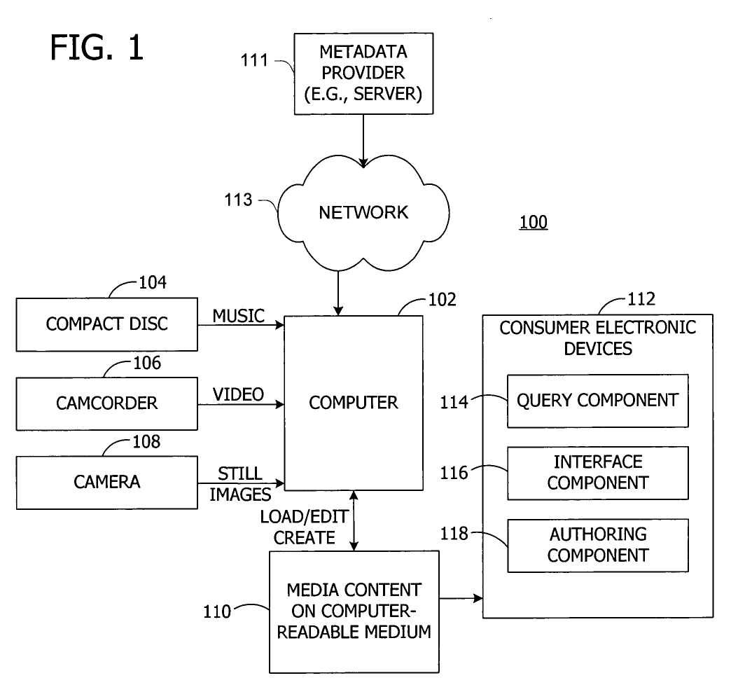

Referring now to the drawings, FIG. 1 illustrates an exemplary multimedia environment in which the invention may be used. A system 100 has one or more computers 102 coupled to one or more devices providing media content including audio data, video data, and/or image data. For example, the devices may include a compact disc (CD) 104, a camcorder 106, or a camera 108. The computer 102 accesses the media content as input and can render or store the media content as a digital media file to a computer-readable medium 110.

In one embodiment, the computer 102 stores media content on a computer-readable medium 110 for use by a media player program associated with a consumer electronic device 112. The consumer electronic device 112 includes any suitable rendering filter or media player or device that is configured to render digital media so that the user can experience the content that is embodied on the medium 110. For example, suitable media player applications include a CD media player and a DVD media player.

Media players, consumer electronic devices 112, or the like may be organized according to the capabilities of the media player. Each media player has a media type that identifies the type of media that the media player is capable of rendering. For example, the media type (also referred to as a playlist summary type, a menu summary type, or the like) includes one or more of the following: audio, video, and still image. Some media players include audio-only players such as portable CD players, car receivers, and DVD players. Other media players further include audio and still image capable players including portable and set-top DVD players optionally capable of rendering images with audio simultaneously. Other media players further include audio, still image, and video capable players. Exemplary consumer electronic devices 112 include, but are not limited to, the following: a portable CD player, a Moving Picture Experts Group audio layer-3 (MP3) player, an audio system in an automobile, a personal digital assistant, a cellular telephone, or the like.

One aspect of the present invention enables the user or, particularly, enables a media player program executing on computing device 112 or client, to access, retrieve, and display for the user, so-called metadata. Those skilled in the art are familiar with metadata, which is simply information about data. In the context of the present invention, metadata includes information related to specific content of a digital media file being played on the media player. Basic metadata includes a title, composer, performer, genre, a description of content, and the like. Extended metadata includes cover art, performer biographies, reviews, related performers, where to buy similar items, upcoming concerts, ticket sales, URLs to other related experiences including purchase opportunities, and the like.

The user of consumer electronic device 112 inserts a computer-readable medium storing a digital media file into computer 102, or otherwise causes the content of the digital media file to be experienced. In the embodiment of FIG. 1, metadata provider 111 matches metadata to the specific media content that is being experienced by the user. Metadata provider 111 then returns the metadata to computer 102. In the examples herein, the media content of the digital media file is described in the context of content embodied on a CD or a DVD. It is to be appreciated and understood that the media content can be embodied on any suitable media, including digital files downloaded to memory accessible by computer 102, and that the specific examples described herein are given to further understanding of the inventive principles. For convenience, a digital media file refers to one or more files representing, for example, a single song track or a collection of tracks such as would be found on an audio CD. The media content may include, without limitation, specially encoded media content in the form of an encoded media file.

In one embodiment, an exemplary consumer electronic device 112 or media player includes or has access to one or more computer-readable media having computer-executable components for obtaining metadata for a media content file. The media content file is stored on a computer-readable medium. In one embodiment, the metadata is available from a metadata provider 111 via a data communication network 113. The computer 102 and metadata provider 111 are coupled to the data communication network 113. While the network 113 in this example is the Internet, the teachings of the invention may be applied to any data communication network.

In the embodiment illustrated in FIG. 1, the components are shown to execute on consumer device 112 for simplicity. It is to be understood that any of the components may execute on the consumer device 112, computer 102 (not shown), or any other computing device (e.g., remote from the user or device 112) or combination thereof. The components include a query component 114, an interface component 116, and an authoring component 118. As described in greater detail herein, the query component 114 requests metadata for the media content file from a metadata provider via a request data structure. The interface component 116 receives a return data structure from the metadata provider. The authoring component 118 associates the return metadata or a portion thereof with namespace identifiers and stores the namespace identifiers and associated metadata with the media content file. The authoring component 118 further determines an identifier value, associates the determined identifier value with media content, assigns the determined identifier value to one or more namespace identifiers, and stores the identifier value and assigned namespace identifier with the media content. Those skilled in the art will note that the invention software may be implemented with any number and organization of components or modules. That is, the invention is not limited to the specific configuration of components 114, 116, and 118. Further, those skilled in the art will note that the invention may include a user interface such as the media player executing on consumer electronic device 112 or may lack a user interface (e.g., perform metadata updates silently in the background independent of a media player).

A playlist is a convenient way to organize groups of audio, video, and image files stored on a computer-readable medium based on metadata associated with each of the files. Metadata for a digital media file includes general information pertaining to the media file itself. This information is typically stored within the file. For example, an audio file may have metadata tags for the song title, song artist, album title, and a rating. The playlist may include, but is not limited to, one or more of the following: a media file, a group of audio files, a group of video files, a group of timed image sequences, and a group of complex parallel combinations of images with audio. For example, a user may create playlists for different performers or different kinds of music or videos based on the metadata for the music or videos. The user also manipulates the created playlists by shuffling or repeating the playlists. Such shuffle or random play options may operate at the group level or at the individual media file level, which allows, for example, playback of all songs by a random artist before proceeding to the next random artist. Playlists allow the user to easily view a listing of media files to sort, search, and quickly navigate.

Requesting Metadata

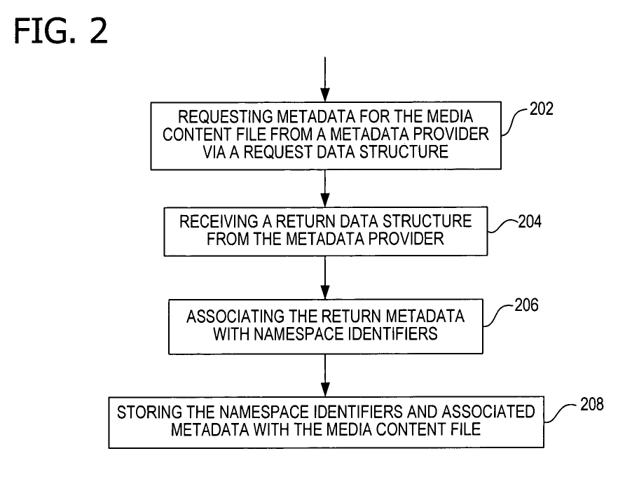

Referring next to FIG. 2, an exemplary flow chart illustrates a communication protocol for requesting metadata according to the invention. The invention includes software executing on the client or other computing device to request and receive metadata for a media content file.

The media content file is stored on a computer-readable medium. The method includes requesting metadata at 202 for the media content file from a metadata provider via a request data structure (MDQ) (e.g., a uniform resource locator or a request file). The request data structure includes a request type identifier defining a type for the computer-readable medium, a request identifier, and one or more metadata elements stored with the media content file. The method further includes receiving at 204 a return data structure (MDR) from the metadata provider. The return data structure stores a return type identifier defining the type for the computer-readable medium, the request identifier, and return metadata corresponding to the requested metadata.

An exemplary request type identifier comprises the text strings “MDQ-CD” or “MDQ-DVD.” An exemplary return type identifier comprises the text strings “MDR-CD” or “MDR-DVD.” The type relates to the various computer-readable media available including but not limited to, a compact disc, a digital versatile disc, and flash memory. The return data structure may also include a delay time interval (e.g., a backoff interval) to instruct the client to postpone additional requests for metadata until after the delay time interval has elapsed for server load balancing reasons.

The metadata provider (e.g., a human operator or a computer) identifies the metadata relevant to or otherwise associated with the media content file as defined in the MDQ query and sends the identified metadata to the requesting client as the return metadata defined in the MDR response. In an embodiment in which the media content file comprises one of a plurality of songs in an album, requesting the metadata includes requesting metadata for the song, and receiving metadata for the plurality of songs in the album as the return metadata.

The method associates the return metadata or a portion thereof with namespace identifiers at 206 including at least one of WMContentID, WMCollectionID, and WMCollectionGroupID (e.g., a box set identifier). The method stores the namespace identifiers and associated metadata with the media content file at 208. Alternatively or in addition, the return metadata and/or namespace identifiers are stored in a cache. Further, the client may request additional metadata from the metadata provider using a portion of the return metadata. The method also classifies the media content based on the return metadata. For example, the method assigns values to the identifiers WMPrimaryClassID, and WMSecondaryClassID.

In another embodiment, the media content file includes media content, one or more identifiers characterizing the media content such as WMContentID, WMCollectionID, WMCollectionGroupID, and an identifier value associated with each of the one or more identifiers. The metadata elements sent to the metadata provider in the request data structure include values associated with any of the namespace identifiers currently available in the media content file. The return metadata comprises a globally unique identifier for one or more of the namespace identifiers.

The requested metadata may be stored in various locations including, but not limited to, a local cache, a network server, and a client computer. That is, the metadata provider may be a software component executing on the same computer as the requesting client (e.g., a media player) or on a different computer.

One or more computer-readable media having computer-executable instructions for performing the method illustrated in FIG. 2. For example, a media player may comprise the computer-executable instructions.

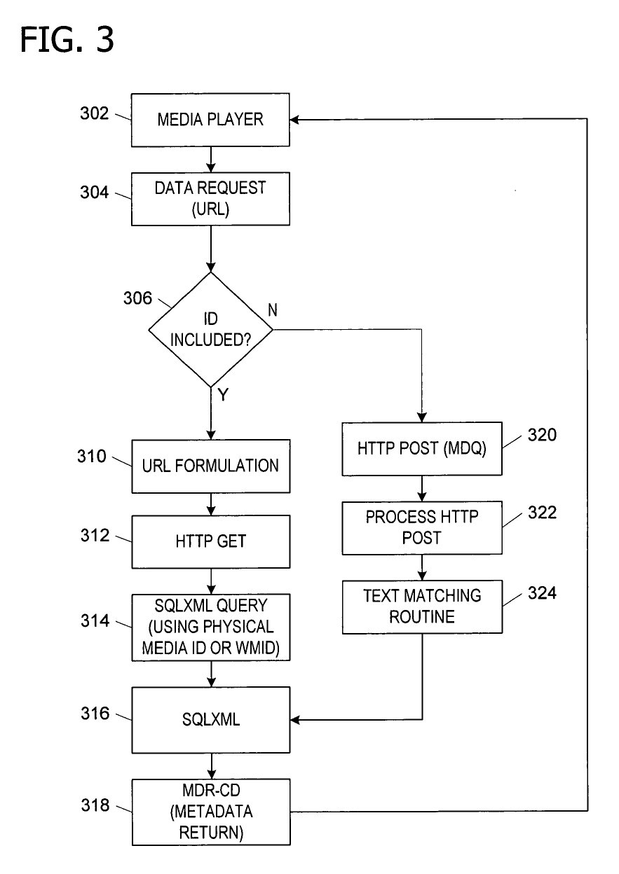

Referring next to FIG. 3, an exemplary flow chart illustrates a specific implementation of the communication protocol for requesting metadata according to the invention. A media player at 302 generates a data request at 304 by determining at 306 if an identifier value is available for inclusion on the data request. If the identifier value is included, the media player formulates a uniform resource locator (URL) at 310 to create an HTTP GET at 312 having various parameters (including the identifier value). An exemplary URL using a WMID identifier value is shown below.

http://windowsmedia.com/redir/GetMDRCD.asp?wmid=8C0E118D−36E7−43A0−8732−24FA855F8A80&version=9.0.0.0000&locale=409&requestid=B1D119EA−4FC8−409F−BF05−D52E0FED2FDB

Exemplary parameters for an HTTP GET are illustrated in Table 1.

TABLE 1
HTTP GET Parameters.

| Parameter | Description |
|---|---|
| TOC | TOC entry from player in CD Deluxe format: e.g. |
| | cd = C + 96 + 528F + 9BAF + E387 + 13C95 |
| WMID | ID for album-MS internal ID. This ID will be in the |
| | form of a GUID-no braces, with dashes: e.g. |
| | 62AA8500-949A-47EE-ADAA-6703FF30EE85 |
| requestID | Request ID from player |
| version | A word-padded, 4-part, version, e.g. |
| | 00009.00001.00010.01576 |
| locale | a locale ID in HEX-e.g. 409 for English U.S. |

For example, the metadata provider generates an SQLXML query using the WMID or a physical media identifier at 314 from the HTTP GET to query a database to obtain metadata associated with the identifier value. The metadata provider executes the SQLXML query at 316 and populates the metadata return data structure (e.g., MDR-CD) at 318 for delivery to the media player. If an identifier is not currently available in the media content file, the media player populates a metadata query data structure (see below) and posts the populated data structure to the metadata provider at 320. The metadata provider processes the POST at 322 and executes an enhanced text matching routine at 324 (see below) that attempts to obtain a metadata match in a non-indexed query fashion unlike using TOC and WMID to locate the requested metadata. The metadata provider populates the metadata return data structure with the relevant metadata at 318 for delivery to the media player.

The data from the HTTP POST is used by a metadata provider to search for metadata in an attempt to find metadata that matches the data from the HTTP POST (e.g., to identify an album associated with a given song). In one embodiment, if both WMID and TOC are sent via the URL, the invention searches for metadata using the WMID first, then searches for metadata using the TOC. In the event that a TOC match does not succeed based on the response sent to the media player, the invention software in the media player may send additional requests for metadata that include the original parameters from the HTTP GET in an XML document in an HTTP POST (see the MDQ data structure below).

Extending the Namespace

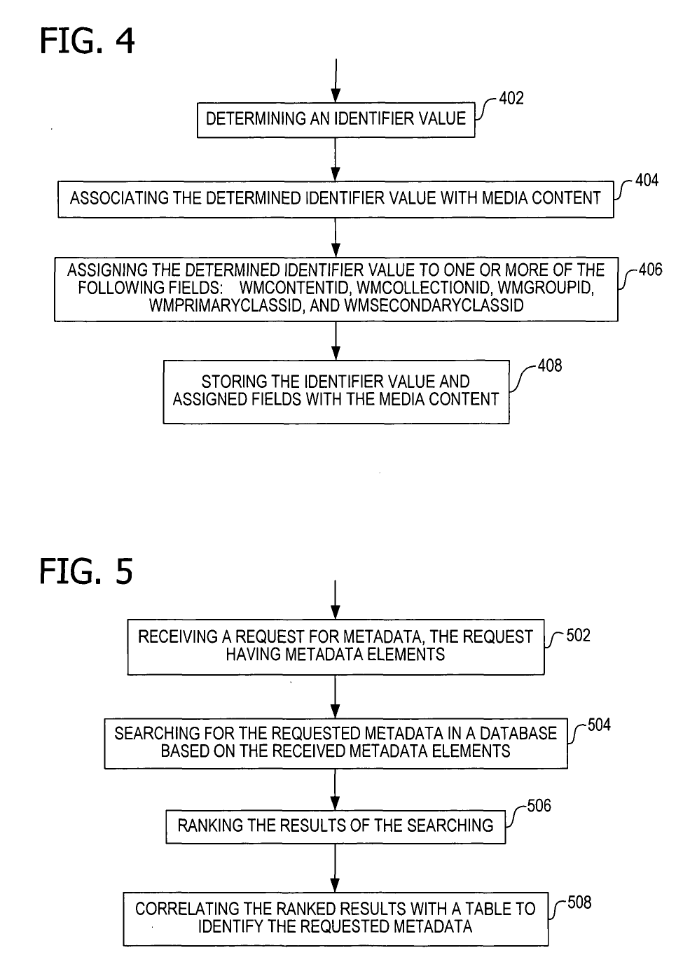

Referring next to FIG. 4, an exemplary flow chart illustrates the creation of new identifier values for the namespace identifiers. The method includes determining an identifier value (e.g., a globally unique identifier) at 402 and associating the determined identifier value with media content at 404. For example, the method includes populating a master reference table with the mapping between the identifier value and the media content. The method further assigns the determined identifier value to one or more of the following fields at 406: WMContentID, WMCollectionID, and WMCollectionGroupID. The method stores the identifier value and assigned fields with the media content (e.g., in a file) at 408. If the media content is new, the method generates the identifier value (e.g., using an application program such as guidgen.exe). One or more computer-readable media having computer-executable instructions for performing the method illustrated in FIG. 4.

Enhanced Text Matching Rules

The metadata source or other metadata provider services request for metadata for media content by identifying relevant metadata. In an embodiment in which the request includes some basic metadata obtained from the medium storing the media file containing the media content, the server performs text matching to identify additional metadata to be returned to the requesting computer.

Referring next to FIG. 5, an exemplary flow chart illustrates operation of text matching software. The exemplary method for processing media content includes receiving a request for metadata having one or more metadata elements currently associated with the media content at 502. The method includes searching for the requested metadata in a database based on the received metadata elements at 504 and ranking the results of the search at 506. The method correlates the ranked results with a table to identify the requested metadata at 508. One or more computer-readable media having computer-executable instructions for performing the method illustrated in FIG. 5. In one example, the request for metadata includes a title for the media content. The metadata provider evaluates the data received via the MDQ data structure to determine the likelihood that the data maps to an entry in the database (e.g., by consulting a table in the metadata database that maps words to albums).

MDQ Data Structure

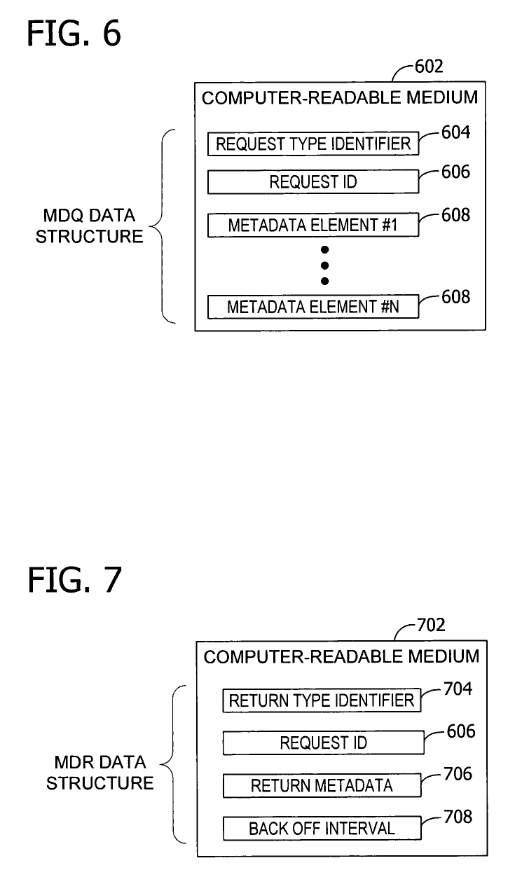

Referring next to FIG. 6, an exemplary block diagram illustrates a metadata query data structure. A computer-readable medium 602 stores a data structure representing a request for metadata (e.g., an MDQ data structure). The data structure is transmitted by a first computing device (e.g., the client) to a second computing device (e.g., the metadata provider) to request metadata for media content. The data structure includes a request type identifier 604 defining a type for a destination computer-readable medium storing the media content, a request identifier 606, and one or more metadata elements 608 stored with the media content. In one embodiment, the request type identifier 604 comprises “MDQ-CD” or “MDQ-DVD.” The type relates to the computer-readable medium storing the media content file and includes, but is not limited to, at least one of the following: a compact disc, a digital versatile disc, and flash memory.

The invention software populates the MDQ data structure and sends the populated structure with a request for metadata. The MDQ data structure applies to any digital media file having some metadata associated with it (e.g., WMA, MP3). In one embodiment, the MDQ data structure is sent using UTF-8 encoding. Table 2 below describes exemplary elements in the MDQ data structure.

TABLE 2
Exemplary MDQ Elements.

| Element | Description |
|---|---|
| MdqRequestID | Index for this MDQ request to enable the player to |
| (e.g., request | map an incoming MDR in cases were the MDQ and |
| identifier 606) | the MDR are processed asynchronously |
| Text (e.g., | Full title of album, artist or track in spoken form. |
| metadata element | This title will include all articles |
| 608) | |
| Word (e.g., | Each word in the album or artist or track-will depend |
| metadata element | on the context of the tag |
| 608) | |
| TrackRequestID | Index per track for each track submitted via the MDQ. |
| (e.g., metadata | This will enable the player to map individual track |
| element 608 | nodes in the MDR back to the MDQ request. |
| TrackNumber | Number of the track in the context of the album in |
| (e.g., metadata | which the track resides |
| element 608) | |

The following extensible markup language (XML) document is an example of the MDQ data structure. The MDQ data structure includes data pulled from the media file and from the computer-readable medium on which the media file is stored. The MDQ data structure shown below includes word splitting.

<METADATA>

<MDQ-CD>

<mdqRequestID>1234-5678</mdqRequestID>
<album>

<title>

<text>This is Album Title A</text>
<word>This</word>
<word>Album</word>
<word>Title</word>
<word>A</word>

</title>
<artist>

<text>Singer and Band Members</text>
<word>Singer</word>
<word>Band</word>
<word>Members</word>

</artist>

</album>
<track>

<trackRequestID>0</trackRequestID>
<trackNumber>3</trackNumber>
<title>

<text>First Song</text>
<word>First</word>
<word>Song</word>

</title>
<fileName>

<text>first_song_03.wma</text>
<word>first</word>
<word>song</word>

</fileName>
<duration>30180</duration>
<artist>

<text>Singer and Band Members</text>
<word>Singer</word>
<word>Band</word>
<word>Members</word>

</artist>

</track>
<track>

...

</track>

</MDQ-CD>

</METADATA>

Metadata sent to the metadata provider may include multiple content identifiers (e.g., multiple metadata elements in the MDQ data structure). Sending multiple content identifiers representing the same media file improves the validation accuracy of the metadata match. For example, when a request is made for CD metadata, only a TOC value may be available to send as a metadata element in the request for metadata. While the TOC value may be in a metadata database maintained by the metadata provider, the mapping may be incorrect (e.g., a publication error). However, if other metadata elements are available from the media file (e.g., a WMID, a DSP generated fingerprint, or textual metadata such as album title, artist, genre, track duration, etc.), the client sends those other metadata elements to the metadata provider. The metadata provider uses all the received metadata elements to identify the relevant metadata and to correlate the match results to compute an accuracy rating.

The accuracy rating or other quality factor enables the client to decide how to apply the returned metadata. For example, if the quality is considered to be a perfect match, then the invention associates the received metadata with the media file without user interaction and overwrites whatever metadata is currently present in the media file. If the quality is considered to be questionable, then the invention prompts the user to confirm the match before altering the media file. In this manner, the invention improves the quality and efficiency of the end user experience.

The identifiers used in the request for metadata are calculated when a computer-readable medium with the media content is inserted into a computer. The values for the identifiers include, but are not limited to, a table of contents (TOC) value, a WMContentID value (e.g., a GUID representing the track of an audio file), a WMCollectionID value (e.g., a GUID representing the album of an audio file), a WMCollectionGroupID value (e.g., a GUID representing the box set of a multi-disc/album set), a fingerprint/hash computed by a digital signal processor (DSP) based on media content that is unique to the track, and metadata (e.g. Mood, Tempo, etc) that is computed by a DSP to further validate the match.

For example, the identifier value may take the form of a physical identifier such as a table of contents (TOC) for a compact disc identifying the specific digital media file based on the offsets of each track on the disc. The TOC, defined by a well-known specification referred to as the Red Book, identifies an audio CD based absolute times for the start of each track. The TOC, found in the CD's lead-in area, is expected to be the same for all like-entitled CDs published from the same source.

Given an item of media content, a request for metadata may be made in various ways including, but not limited to, one of the ways described herein. In one embodiment, the invention formulates a network address with one or more query string parameters. The formulated network address represents the request data structure. The query string parameter includes an identifier and a value associated therewith. The identifier or a portion thereof includes the text string WMED, CD, TOC, or DVD ID. In one embodiment, the WMID is the WMCollectionID for the media content. The associated value corresponds to the media content. The formulated network address may include a uniform resource locator (URL). For example, a request for metadata includes a WMID identifier corresponding to a specific album or track such as in the following URL.

http://windowsmedia.com/redir/GetMDRCD.asp?wmid=8C0E118D-36E7−43A0−8732−24FA851F8A80&version=9.0.0.0000&locale=409&requestid=B1D19EA−4FC8−409F−BF05−D52E0FED2FDB

In another example, a request for metadata includes a TOC identifier (e.g., CD) corresponding to a physical media identifier such as in the following URL. The TOC value is calculated from the medium as known in the art.

http://windowsmedia.com/redir/GetMDRCD.asp?cd=E+96+44E0+92F4+F112+101C1+1548E+19BAB+1DF9C+232AA+28A4B+2A0AF+2F6E3+33FBA+37E9E+4258D&version=9.0.0.0000&locale=409&requestid=B1D119EA−4FC8−409F−BF05−D52E0FED2FDB

In another example, a request for metadata includes an HTTP POST for fuzzy matching XML using the MDQ data structure such as in the following URL.

http://windowsmedia.com/redir/GetMDRCDPOSTURL.asp?version=9.0.0.0000&locale=409

In the following example, the URL request returns all data about the media file.

http://windowsmedia.com/redir/GetMDRCD.asp?cd=E+96+44E0+92F4+F112+101C1+1548E+19BAB+1DF9C+232AA+28A4B+2A0AF+2F6E3+33FBA+37E9E+4258D&version=9.0.0.0000&locale=409&requestid=B1D119EA−4FC8−409F−BF05−D52E0FED2FDB

The client may then make a second request using some of the returned data to obtain additional metadata such as album art and ticket information. Controlling access to metadata servers via uniform resource locators reduces cost by reducing the unauthorized drain of server resources and namespace pollution and is thus not merely a design choice.

MDR Data Structure

Referring next to FIG. 7, an exemplary block diagram illustrates a metadata return data structure. A computer-readable medium 702 stores a data structure sent from a first computing device (e.g., the metadata provider) to a second computing device (e.g., the client) in response to a request for metadata sent by the second computing device. The data structure includes a return type identifier 704 defining a type for a destination computer-readable medium storing the media content, the request identifier 606, and return metadata 706 corresponding to the requested metadata. In one embodiment, the request type identifier 704 comprises MDR-CD or MDR-DVD. The MDR data structure further includes a back off interval 708 or other delay interval specifying a time period for postponing additional requests for metadata by the second computing device. As with the MDQ data structure, the type in the MDR data structure relates to various computer-readable media including, but not limited to, one of the following: a compact disc, a digital versatile disc, and flash memory.

The following exemplary MDR-CD data structure illustrates the format in which the metadata provider returns CD metadata such as return metadata 706 to the requesting media player:

<METADATA xmlns:sql=“urn:schemas-com:xml-sql”>

<MDR-CD>

<version>4.0</version>
<mdqRequestID/>
<WMCollectionID>52A916D1-2BF1-4E17-AC50-

03BE7CF8647A</WMCollectionID>

<WMCollectionGroupID>52A916D1-2BF1-4E17-AC50-

03BE7CF8647A</WMCollectionGroupID>

<uniqueFileID>ProviderAa_id=R 228492</uniqueFileID>
<albumTitle>Album A</albumTitle>
<albumArtist>Artist A</albumArtist>
<releaseDate>1995-10-10</releaseDate>
<label>Record Company A</label>
<genre>Rock</genre>
<providerStyle>Rock</providerStyle>
<publisherRating>7</publisherRating>
<buyParams>providerName=ProviderAamp;albumID=52A916D1-2BF1-4E17-

AC50-
03BE7CF8647A&amp;a_id=R%20%20%20228492&amp;album=Album%20A&amp;art
istID=5FE0A694-4F43-4626-9976-
D7B0F5F5D60A&amp;p_id=P%20%20%20%2023015&amp;artist=Artist%20A</buyPa
rams>

<largeCoverParams>200/drc000/c079/c079886248o.jpg</largeCoverParams>
<smallCoverParams>075/drc000/c079/c079886248o.jpg</smallCoverParams>
<moreInfoParams>a_id=R%20%20%20228492</moreInfoParams>
<dataProvider>ProviderA</dataProvider>
<dataProviderParams>Provider=ProviderA</dataProviderParams>
<dataProviderLogo>Provider=ProviderA</dataProviderLogo>
<track>

<trackRequestID/>
<WMContentID>F88F2D94-5EEF-4DAC-A720-

7C6F9242412D</WMContentID>

<trackTitle>Song A</trackTitle>
<uniqueFileID>ProviderAp_id=P 23015;ProviderAt_id=T

1915536</uniqueFileID>

<trackNumber>1</trackNumber>
<trackPerformer>Artist A</trackPerformer>
<trackComposer>Artist A</trackComposer>
<trackConductor/>
<period/>

</track>
<track>

<trackRequestID/>
<WMContentID>B9814FB1-E6CC-40EF-B0C4-

D898FF81ADA7</WMContentID>

<trackTitle>Song B</trackTitle>
<uniqueFileID>ProviderAp_id=P 23015;ProviderAt_id=T

1915537</uniqueFileID>

<trackNumber>2</trackNumber>
<trackPerformer>Artist A</trackPerformer>
<trackComposer>Artist A</trackComposer>
<trackConductor/>
<period/>

</track>
...
<track>

<trackRequestID/>
<WMContentID>A13FD288-8459-4B7B-B69E-

C16CCFD39BC8</WMContentID>

<trackTitle>Song N</trackTitle>
<uniqueFileID>ProviderAp_id=P 23015;ProviderAt_id=T

1915549</uniqueFileID>

<trackNumber>N</trackNumber>
<trackPerformer>Artist A</trackPerformer>
<trackComposer>Artist A</trackComposer>
<trackConductor/>
<period/>

</track>

</MDR-CD>
<Backoff>

<Time>5</Time>

</Backoff>

</METADATA>

The following exemplary MDR-DVD data structure illustrates the format in which the metadata provider returns DVD metadata such as return metadata 706 to the requesting media player:

<METADATA>
<MDR-DVD>

<version>2.0</version>
<dvdTitle>This is Movie A</dvdTitle>
<studio>Company A Home Video</studio>
<leadPerformer>Actor A, Actress B</leadPerformer>
<actors>Actor A, Actor B</actors>
<director>Director A</director>
<MPAARating>NR</MPAARating>
<releaseDate>2003-07-18</releaseDate>
<genre>Comedy;Children's/Family;Fantasy Comedy;Children's Fantasy</genre>
<largeCoverParams>dvdcover/cov150/drt000/t091/t09186csm0f.jpg</largeCover

Params>

<smallCoverParams>dvdcover/cov075/drt000/t091/t09186csm0f.jpg</smallCove

rParams>

<dataProvider>Metadata Provider A</dataProvider>
<dataProviderParams>providerinfo/ProviderARedir.asp</dataProviderParams>
<dataProviderLogo>providerinfo/logo.gif</dataProviderLogo>
<buyParams>dv_id=V%20%20%20144390&amp;dvdTitle=This%20is%20Movi

e%20A</buyParams>

<moreInfoParams>dv_id=V%20%20%20144390</moreInfoParams>
<title>

<titleNum>1</titleNum>
<titleTitle>This is Movie A</titleTitle>
<studio>Company A Home Video</studio>
<director>Director A</director>
<leadPerformer>Actor A, Actress B</leadPerformer>
<actors>Actor A, Actor B</actors>
<MPAARating>NR</MPAARating>
<genre>Animation</genre>
<providerRating>50</providerRating>
<chapter>

<chapterNum>1</chapterNum>
<chapterTitle>Logos/Main Title</chapterTitle>

</chapter>
<chapter>

<chapterNum>2</chapterNum>
<chapterTitle>Introduction</chapterTitle>

</chapter>
<chapter>

<chapterNum>3</chapterNum>
<chapterTitle>Action Scene</chapterTitle>

</chapter>
<chapter>

<chapterNum>4</chapterNum>
<chapterTitle>Finale</chapterTitle>

</chapter>

</title>
<title>

<titleNum>2</titleNum>
<titleTitle>This is Movie B</titleTitle>
<studio>Company A Home Video</studio>
<director>Director A</director>
<leadPerformer>Actor C</leadPerformer>
<actors>Actor D;Actress E</actors>
<MPAARating>NR</MPAARating>
<genre>Animation</genre>
<providerRating>50</providerRating>
<chapter>

<chapterNum>1</chapterNum>
<chapterTitle>Inside the House</chapterTitle>

</chapter>
<chapter>

<chapterNum>2</chapterNum>
<chapterTitle>Outside the House</chapterTitle>

</chapter>

</title>

</MDR-DVD>
</METADATA>

The invention includes optimizations that enable efficient use of the network. For example, when a client requests metadata for a track, the metadata source always returns metadata for a complete album. The media player stores the album information in a local cache. On subsequent requests for metadata for other tracks, the client requests the metadata from the local cache instead of the metadata provider. If CDs have an average of fifteen tracks, this method improves performance by greater than fifteen times for users who have full CDs.

Optimizations for Requesting Metadata

The invention includes an exemplary back off protocol for postponing additional requests for metadata in response to delays. The client implements the back off protocol in response to any delay including delay caused by the metadata provider and by a network connecting the requesting client and the metadata provider (e.g., network delays such as HTTP 500 series errors).

In the exemplary protocol, the client receives notice from the metadata provider that the metadata provider is unable to respond to the request for metadata (e.g., the metadata provider may be out of resources and send an HTTP 503 error or specify a back-off interval in the MDR data structure). The metadata provider determines the threshold at which such notice is sent. The client responds to the notice by implementing a back-off protocol such as described herein. In particular, the client ceases sending requests for metadata for a period of time. For example, an initial back-off period may default to one hour. To provide more fine-grained control and flexible management, the metadata provider specifies a back-off interval in the metadata return data structure received by the client. The specified back-off interval may be dependent on the type of error being experienced by the metadata provider.

The exemplary XML document below shows a metadata return data structure specifying a twenty second back-off time interval. In this example, the metadata provider also returns the requested metadata. After the back-off interval has elapsed, the client may send another request and include the specified time interval for use by the metadata provider.

<METADATA xmlns:sql=“urn:schemas-com:xml-sql”>

<MDR-CD>

<version>4.0</version>
<WMCollectionID>09B60586-6CA5-453F-89C5-

BD668347A3B6</WMCollectionID>

<WMCollectionGroupID>09B60586-6CA5-453F-89C5 -

BD668347A3B6</WMCollectionGroupID>

...
</MDR-CD>
<Backoff>

<Time>20</Time>
</Backoff>

</METADATA>

In the following example, a metadata provider communicates a back-off interval to the client but omits a metadata return data structure (e.g., due to a lack of resources to service the request).

<METADATA xmlns:sql=“urn:schemas-com:xml-sql”>

<Backoff>

<time>20</time>

</Backoff>

</METADATA>

In the following example, a metadata provider communicates a back-off interval along with an error code related to the match request.

<METADATA>

<mdqRequestID>E8021742-C30F-42A0-9650-

0E0F6D963BC2</mdqRequestID>

<ResponseCode>Track Mode</ResponseCode>
<ResponseCode>At least one track has no track/artist element.</ResponseCode>
<ResponseCode>Not enough data sent to process request/ResponseCode>
<Backoff>

<Time>20</Time>

</Backoff>

</METADATA>

Namespace Identifiers

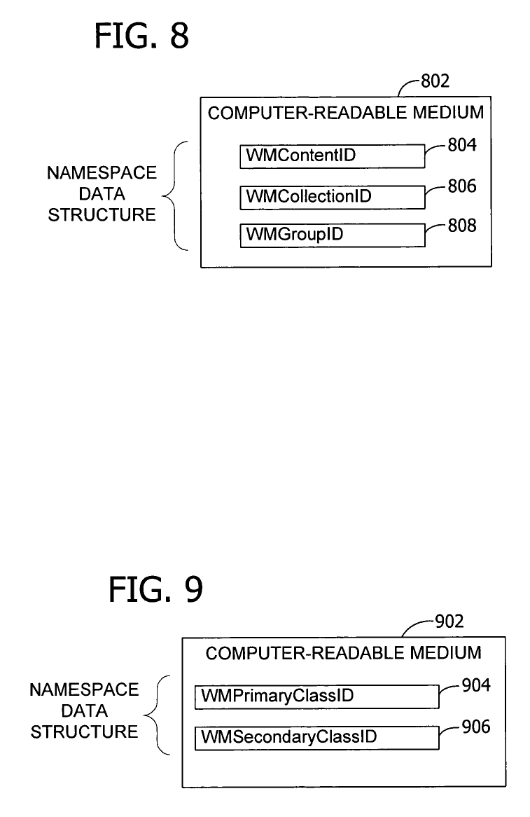

Referring next to FIG. 8, an exemplary block diagram illustrates a computer-readable medium 802 storing a namespace data structure for identifying media content. The data structure includes a first field (e.g., WMContentID 804) storing a content identifier value, a second field (e.g., WMCollectionID 806) storing a collection identifier value, and a third field (e.g., WMCollectionGroupID 808) storing a group identifier value. The first, second, and third fields represent different levels of granularity for identifying the media content. In one embodiment, the content identifier value, the collection identifier value, and the group identifier value each comprise a globally unique identify (e.g., a box set identifier).

Those skilled in the art will note that the specific namespace identifiers described herein (FIG. 8 and FIG. 9) advantageously provide granularity in characterizing the media content. For example, the following identifiers represent increasing levels of granularity for classifying the media content: WMCollectionGroupID 808, WMCollectionID 806, and WMContentID 804. The specific namespace identifiers are not merely a design choice.

Upon receipt of metadata for media content, the media player assigns three values to the three identifiers WMContentID 804 (e.g., per track), WMCollectionID 806 (e.g., per album), and WMCollectionGroupID 808 (e.g., spans CDs). In one embodiment, the values are GUIDs. If a media file lacks identifiers, the invention classifies the media file by assigning identifier values to it. Future operations involving the media file use the assigned identifier values. For example, using the identifiers described above, a software tool may identify duplicates of songs on a user's computer.

Table 3 below describes WMContentID 804, WMCollectionID 806, and WMCollectionGroupID 808.

TABLE 3
Namespace Identifiers.

| | Data | |
|---|---|---|
| Attribute | Type | Description |
| WMContentID | GUID | Discrete media content. This |
| | | identifier represents the |
| | | performance of a particular |
| | | work as it relates to a |
| | | specific collection (e.g., an |
| | | album). The same media content |
| | | that may appear in a different |
| | | collection will have a different |
| | | WMContentID. |
| WMCollectionID | GUID | Identifies a specific media |
| | | collection (e.g., an album). This |
| | | identifier refers to a single |
| | | physical medium even when the |
| | | medium exists as part of a |
| | | multiple-volume set. |
| WMCollectionGroupID | GUID | If a collection includes multiple |
| | | physical collections within it |
| | | (e.g., a CD box set), this |
| | | identifier identifies the individual |
| | | discs in the set. |
| *UFID | string | Unique file identifiers for the CDs |
| | | and tracks |

The namespace identifiers apply to other media such as DVD. For example, WMContentID 804 maps to a title, WMCollectionID 806 maps to a disc, and WMCollectionGroupID 808 maps to a disc set. Those skilled in the art will appreciate that additional extensions are within the scope of the invention. For example, a ChapterID identifier may be added to provide a more fine-grained reference. In another example, an identifier that is broader than WMCollectionGroupID 808 may be added to cover such long running groupings as a television miniseries or a season's worth of a particular television show.

Collection Group Handling

Some metadata providers organize album information in a way that aggregates all the tracks in a multi-album set into a single album. Further, some DVDs are re-packaged into multi-release sets. The CollectionGroupID identifier such as WMCollectionGroupID 808 addresses the issue of multi-volume sets of all types. The CollectionGroupID for the set enables explicit mapping between the single disc and the set to which it belongs. The CollectionGroupID enables the media player to display an accurate hierarchy in the media player in instances where a specific album belongs to a multi-album set. This identifier represents various collections including, but not limited to, multiple-CD collections considered to be a single album, multiple-album collections (e.g., “box-sets”) which may include a multiple-CD collection, multiple-disc DVD collections (e.g., 2-disc movie releases), and multiple DVDs sold together as a single collection where each disc may include multiple discs. In one embodiment, the user specifies via the media player whether the disc in question belongs to a multiple-disc set.

Media Class Identifiers

Referring next to FIG. 9, an exemplary block diagram illustrates a computer-readable medium 902 storing a namespace data structure for classifying media content. The data structure includes a first field (e.g., WMPrimaryClassID 904) storing a primary identifier value and a second field (e.g., WMPrimaryClassID 906) storing a secondary identifier value. The first and second fields represent increasing levels of granularity for classifying the media content. The primary identifier value and the secondary identifier value each include, but are not limited to, audio, video, and other.

The two media class identifiers or tags formulate a namespace representing a media type. The primary class identifier (e.g., WMPrimaryClassID 904) is granular enough to permit a gross classification with the secondary class identifier (e.g., WMPrimaryClassID 906) serving as a refinement. The media class identifiers are generated when a media file is added to a media library on the user's computer. The identifiers are later stored in the media file. For example, the identifiers may appear as general properties in advanced streaming format (ASF) files (WMA, WMV, ASF, etc). In another example, the identifiers may be tagged as PRIV in MP3 files.

In one embodiment, values for the WMPrimaryClassID 904 and WMSecondaryClassID 906 identifiers include GUIDs. A list of valid GUID values is listed in Appendix A. Additional GUID values may be assigned as needed. However, the pool of assigned GUIDs is controlled and limited to prevent confusion and pollution of the namespace (e.g., GUIDs generated and assigned by third parties). For example, only an authorized user may generate a new GUID for WMSecondaryClassID 906 representing “Video_Cookbooks.” It is contemplated by the inventors that the identifier value may include any uniquely generated value. The identifier values are documented and disclosed or distributed to enable others to use the values in their applications. In one form, the values are written to the media file as a spaceless, dashed GUID string, though other means for storing the values are contemplated to be within the scope of the invention. For example, the identifiers may be stored as shown in equations 1 and 2 below.

WMPrimaryClassID=“BFD37AC7−404E−442B−A929−840A7C671081” (1)

WMSecondaryClassID=“AB70FF1B−9091−4B1C−84FE−237AE73B82AA“ (2)

Media Class Identifiers Auto-Classification Heuristics

If a media file is lacking either of the media class identifiers, the invention classifies or otherwise characterizes the media file and assigns values for the media class identifiers (e.g., when authoring new media content). For example, when a user bums a CD, the primary class identifier is set to “audio” and a null value is set for the secondary class identifier (or no secondary identifier is provided). For existing media files, the invention examines other identifiers stored in the media file to identify and assign the proper values for the media class identifiers. For example, if the media file has a value for an identifier labeled WM/AlbumArtist, the invention concludes that the media file is of type AUDIO/MUSIC.

If the user moves the media content from one schema to another within the player user interface, the invention updates the primary class identifier value and secondary class identifier value accordingly. For example, if the media player moves a media file from music to video, the primary identifier changes to video and the secondary identifier is set to null. In another example, the media player prompts the user with “Do you want to move all other media files of this type too?” If the user responds in the affirmative, the media player searches for all content with the same media class identifiers and moves such content to the proper vertical schema. During the move, the invention updates the media class identifiers for each file to the new schema location.

Exemplary Operating Environment

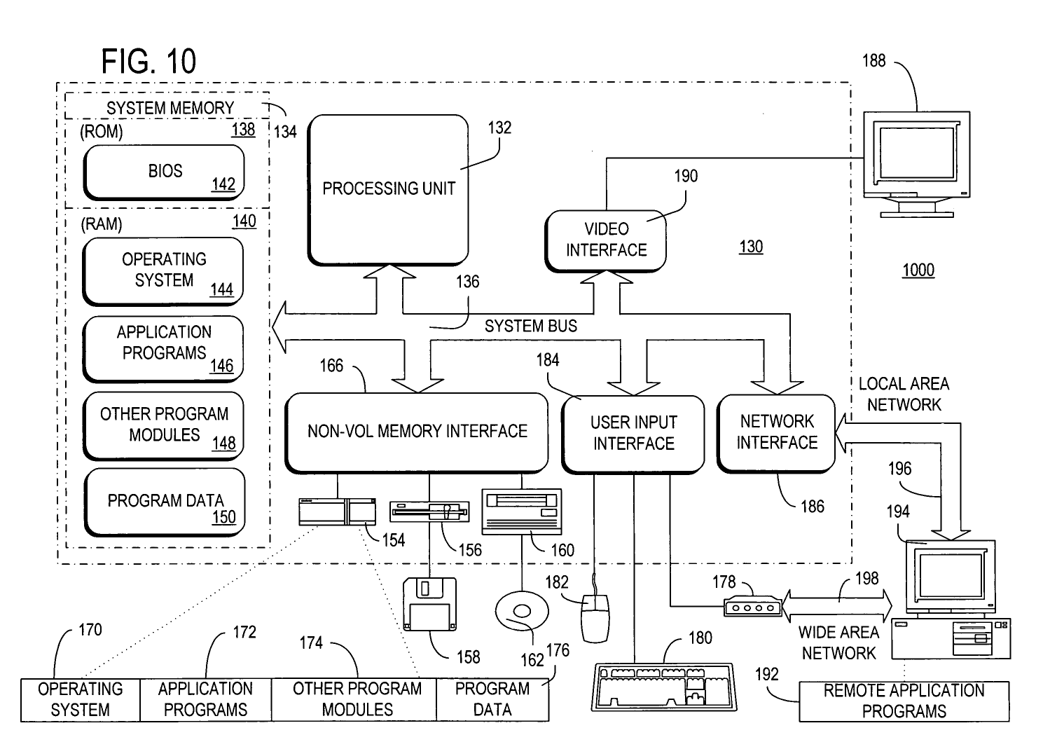

FIG. 10 shows one example of a general purpose computing device in the form of a computer 130. In one embodiment of the invention, a computer such as the computer 130 is suitable for use in the other figures illustrated and described herein. Computer 130 has one or more processors or processing units 132 and a system memory 134. In the illustrated embodiment, a system bus 136 couples various system components including the system memory 134 to the processors 132. The bus 136 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 130 typically has at least some form of computer readable media. Computer readable media, which include both volatile and nonvolatile media, removable and non-removable media, may be any available medium that can be accessed by computer 130. By way of example and not limitation, computer readable media comprise computer storage media and communication media. Computer storage media include volatile and nonvolatile, removable and non-removable media implemented in any method or technology for storage of information such as computer readable instructions, data structures, program modules or other data. For example, computer storage media include RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium that can be used to store the desired information and that can be accessed by computer 130. Communication media typically embody computer readable instructions, data structures, program modules, or other data in a modulated data signal such as a carrier wave or other transport mechanism and include any information delivery media. Those skilled in the art are familiar with the modulated data signal, which has one or more of its characteristics set or changed in such a manner as to encode information in the signal. Wired media, such as a wired network or direct-wired connection, and wireless media, such as acoustic, RF, infrared, and other wireless media, are examples of communication media. Combinations of the any of the above are also included within the scope of computer readable media.

The system memory 134 includes computer storage media in the form of removable and/or non-removable, volatile and/or nonvolatile memory. In the illustrated embodiment, system memory 134 includes read only memory (ROM) 138 and random access memory (RAM) 140. A basic input/output system 142 (BIOS), containing the basic routines that help to transfer information between elements within computer 130, such as during start-up, is typically stored in ROM 138. RAM 140 typically contains data and/or program modules that are immediately accessible to and/or presently being operated on by processing unit 132. By way of example, and not limitation, FIG. 10 illustrates operating system 144, application programs 146, other program modules 148, and program data 150.

The computer 130 may also include other removable/non-removable, volatile/nonvolatile computer storage media. For example, FIG. 10 illustrates a hard disk drive 154 that reads from or writes to non-removable, nonvolatile magnetic media. FIG. 10 also shows a magnetic disk drive 156 that reads from or writes to a removable, nonvolatile magnetic disk 158, and an optical disk drive 160 that reads from or writes to a removable, nonvolatile optical disk 162 such as a CD-ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 154, and magnetic disk drive 156 and optical disk drive 160 are typically connected to the system bus 136 by a non-volatile memory interface, such as interface 166.

The drives or other mass storage devices and their associated computer storage media discussed above and illustrated in FIG. 10, provide storage of computer readable instructions, data structures, program modules and other data for the computer 130. In FIG. 10, for example, hard disk drive 154 is illustrated as storing operating system 170, application programs 172, other program modules 174, and program data 176. Note that these components can either be the same as or different from operating system 144, application programs 146, other program modules 148, and program data 150. Operating system 170, application programs 172, other program modules 174, and program data 176 are given different numbers here to illustrate that, at a minimum, they are different copies.

A user may enter commands and information into computer 130 through input devices or user interface selection devices such as a keyboard 180 and a pointing device 182 (e.g., a mouse, trackball, pen, or touch pad). Other input devices (not shown) may include a microphone, joystick, game pad, satellite dish, scanner, or the like. These and other input devices are connected to processing unit 132 through a user input interface 184 that is coupled to system bus 136, but may be connected by other interface and bus structures, such as a parallel port, game port, or a Universal Serial Bus (USB). A monitor 188 or other type of display device is also connected to system bus 136 via an interface, such as a video interface 190. In addition to the monitor 188, computers often include other peripheral output devices (not shown) such as a printer and speakers, which may be connected through an output peripheral interface (not shown).

The computer 130 may operate in a networked environment using logical connections to one or more remote computers, such as a remote computer 194. The remote computer 194 may be a personal computer, a server, a router, a network PC, a peer device or other common network node, and typically includes many or all of the elements described above relative to computer 130. The logical connections depicted in FIG. 10 include a local area network (LAN) 196 and a wide area network (WAN) 198, but may also include other networks. LAN 136 and/or WAN 138 can be a wired network, a wireless network, a combination thereof, and so on. Such networking environments are commonplace in offices, enterprise-wide computer networks, intranets, and global computer networks (e.g., the Internet).

When used in a local area networking environment, computer 130 is connected to the LAN 196 through a network interface or adapter 186. When used in a wide area networking environment, computer 130 typically includes a modem 178 or other means for establishing communications over the WAN 198, such as the Internet. The modem 178, which may be internal or external, is connected to system bus 136 via the user input interface 184, or other appropriate mechanism. In a networked environment, program modules depicted relative to computer 130, or portions thereof, may be stored in a remote memory storage device (not shown). By way of example, and not limitation, FIG. 10 illustrates remote application programs 192 as residing on the memory device. It will be appreciated that the network connections shown are exemplary and other means of establishing a communications link between the computers may be used.

Generally, the data processors of computer 130 are programmed by means of instructions stored at different times in the various computer-readable storage media of the computer. Programs and operating systems are typically distributed, for example, on floppy disks or CD-ROMs. From there, they are installed or loaded into the secondary memory of a computer. At execution, they are loaded at least partially into the computer's primary electronic memory. The invention described herein includes these and other various types of computer-readable storage media when such media contain instructions or programs for implementing the steps described below in conjunction with a microprocessor or other data processor. The invention also includes the computer itself when programmed according to the methods and techniques described herein.

For purposes of illustration, programs and other executable program components, such as the operating system, are illustrated herein as discrete blocks. It is recognized, however, that such programs and components reside at various times in different storage components of the computer, and are executed by the data processor(s) of the computer.

Although described in connection with an exemplary computing system environment, including computer 130, the invention is operational with numerous other general purpose or special purpose computing system environments or configurations. The computing system environment is not intended to suggest any limitation as to the scope of use or functionality of the invention. Moreover, the computing system environment should not be interpreted as having any dependency or requirement relating to any one or combination of components illustrated in the exemplary operating environment. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, mobile telephones, network PCs, minicomputers, mainframe computers, distributed computing environments that include any of the above systems or devices, and the like.

The invention may be described in the general context of computer-executable instructions, such as program modules, executed by one or more computers or other devices. Generally, program modules include, but are not limited to, routines, programs, objects, components, and data structures that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

In operation, computer 130 executes computer-executable instructions such as those illustrated in FIGS. 2-5 to obtain metadata for media content. Those skilled in the art will note that operation of software routines of the invention can be implemented in numerous ways all within the scope of the invention. For example, the methods described herein may be implemented as a set of application programming interfaces (APIs) available to the media player program and to the operating system executing on computer 130. In another embodiment, the software routines described herein may be implemented as an application program executing on computer 130 that interfaces with the operating system and media player program to perform the methods described herein. In yet another embodiment, the software routines described herein may be implemented as part of the operating system executing on computer 102 with an API available to the media player.

Those skilled in the art will note that the order of execution or performance of the methods illustrated and described herein is not essential, unless otherwise specified. That is, it is contemplated by the inventors that elements of the methods may be performed in any order, unless otherwise specified, and that the methods may include more or less elements than those disclosed herein.

Unless otherwise noted, the example album titles, song titles, artist names, companies, organizations, products, domain names, uniform resource locators, e-mail addresses, logos, people, places and events depicted herein are fictitious, and no association with any real album title, song title, artist name, company, organization, product, domain name, e-mail address, logo, person, place or event is intended or should be inferred.

When introducing elements of the present invention or the embodiment(s) thereof, the articles “a,” “an,” “the,” and “said” are intended to mean that there are one or more of the elements. The terms “comprising,” “including,” and “having” are intended to be inclusive and mean that there may be additional elements other than the listed elements.

In view of the above, it will be seen that the several objects of the invention are achieved and other advantageous results attained.

As various changes could be made in the above constructions, products, and methods without departing from the scope of the invention, it is intended that all matter contained in the above description and shown in the accompanying drawings shall be interpreted as illustrative and not in a limiting sense.

[image]

What is claimed is:

1. A method for obtaining metadata for a media content file storing media content, said media content file being stored on a computer-readable medium, said method comprising:
requesting metadata for the media content file from a metadata provider via a request data structure, said request data structure comprising a request type identifier defining a type for the computer-readable medium, a request identifier, and one or more metadata elements stored with the media content file; and
receiving a return data structure from the metadata provider, said return data structure storing a return type identifier defining the type for the computer-readable medium, the request identifier, and return metadata corresponding to the requested metadata.

2. The method of claim 1, wherein the return metadata comprises metadata determined by the metadata provider to be associated with the media content file.

3. The method of claim 1, wherein the request type identifier comprises MDQ-CD or MDQ-DVD.

4. The method of claim 1, wherein the return type identifier comprises MDR-CD or MDR-DVD.

5. The method of claim 1, wherein the type relates to at least one of the following: a compact disc, a digital versatile disc, and flash memory.

6. The method of claim 1, wherein the computer-readable medium comprises one or more of the following: a compact disc, a digital versatile disc, and flash memory.

7. The method of claim 1, wherein the metadata provider comprises a human or a computer.

8. The method of claim 1, wherein the return data structure comprises a delay time interval, and further comprising postponing additional requests for metadata until after the delay time interval has elapsed.

9. The method of claim 1, further comprising:
associating the return metadata or a portion thereof with namespace identifiers including at least one of WMContentID, WMCollectionID, and WMCollectionGroupID; and
storing the namespace identifiers and associated metadata with the media content file.

10. The method of claim 9, wherein the return metadata comprises a globally unique identifier.

11. The method of claim 1, further comprising classifying the media content with namespace identifiers including at least one of WMPrimaryClassID and WMSecondaryClassID.

12. The method of claim 1, further comprising associated the return metadata or a portion thereof with a namespace identifier representing a box set identifier.

13. The method of claim 1, wherein the metadata elements in the request data structure comprise values associated with namespace identifiers including at least one of WMContentID, WMCollectionID, WMCollectionGroupID, WMPrimaryClassID, and WMSecondaryClassID, wherein the values and namespace identifiers are stored in the media content file.

14. The method of claim 13, wherein requesting the metadata comprises requesting the metadata from at least one of the following: a local cache, a network server, and a client computer.

15. The method of claim 1, wherein the media content file comprises one of a plurality of songs in an album, wherein requesting the metadata comprises requesting metadata for the song, and wherein the return metadata comprises metadata for the plurality of songs in the album.

16. The method of claim 1, further comprising storing the return metadata in a cache.

17. The method of claim 1, further comprising storing the return metadata with the media content file.

18. The method of claim 1, further comprising requesting additional metadata from the metadata provider using a portion of the return metadata.

19. The method of claim 1, wherein requesting the metadata comprises formulating a network address with one or more query string parameters, said formulated network address representing the request data structure.

20. The method of claim 1, wherein the network address comprises a uniform resource locator.

21. The method of claim 1, wherein the metadata provider performs:
receiving the request data structure from a computing device;
searching for the requested metadata in a database based on the received metadata elements;
ranking the results of said searching;
correlating the ranked results with a table storing metadata to identify the requested metadata;
populating the return data structure with the identified metadata; and
sending the populated return data structure to the computing device.

22. One or more computer-readable media having computer-executable instructions for performing the method of claim 1.

23. A method comprising:
determining an identifier value;
associating the determined identifier value with media content; and
assigning the determined identifier value to one or more of the following fields: WMContentID, WMCollectionID, WMCollectionGroupID, WMPrimaryClassID, and WMSecondaryClassID; and
storing the identifier value and assigned fields with the media content.

24. The method of claim 23, wherein the identifier value comprises a globally unique identifier.

25. The method of claim 23, wherein the identifier value comprises a class or type for the media content.

26. The method of claim 23, wherein determining the identifier value comprises generating the identifier value.

27. The method of claim 23, wherein associating the determined identifier value comprises populating a reference table.

28. One or more computer-readable media having computer-executable instructions for performing the method of claim 23.

29. One or more computer-readable media having computer-executable components for obtaining metadata for a media content file storing media content, said media content file being stored on a computer-readable medium, said components comprising:
a query component for requesting metadata for the media content file from a metadata provider via a request data structure, said request data structure comprising a request type identifier defining a type for the computer-readable medium, a request identifier, and one or more metadata elements stored with the media content file; and
an interface component for receiving a return data structure from the metadata provider in response to the request sent by the query component, said return data structure storing a return type identifier defining the type for the computer-readable medium, the request identifier, and return metadata corresponding to the requested metadata.

30. The computer-readable media of claim 29, wherein the return metadata comprises metadata determined by the metadata provider to be associated with the media content file.

31. The computer-readable media of claim 29, wherein the request type identifier comprises MDQ-CD or MDQ-DVD.

32. The computer-readable media of claim 29, wherein the return type identifier comprises MDR-CD or MDR-DVD.

33. The computer-readable media of claim 29, further comprising an authoring component for:
associating the return metadata or a portion thereof with namespace identifiers including at least one of WMContentID, WMCollectionID, and WMCollectionGroupID; and
storing the namespace identifiers and associated metadata with the media content file.

34. The computer-readable media of claim 33, wherein the authoring component further classifies the media content using other namespace identifiers including at least one of WMPrimaryClassID and WMSecondaryClassID.

35. The computer-readable media of claim 33, wherein the authoring component further comprises:
determining an identifier value;
associating the determined identifier value with media content; and
assigning the determined identifier value to one or more of the following namespace identifiers: WMContentID, WMCollectionID, and WMCollectionGroupID; and
storing the identifier value and assigned namespace identifiers with the media content.

36. The computer-readable media of claim 29, wherein the metadata elements in the request data structure comprise values associated with namespace identifiers including at least one of WMContentID, WMCollectionID, WMCollectionGroupID, WMPrimaryClassID, and WMSecondaryClassID, wherein the values and namespace identifiers are stored in the media content file.

37. A media player comprising computer-executable instructions for obtaining metadata for a media content file, said media content file being stored on a computer-readable medium, said instructions comprising:
requesting metadata for the media content file from a metadata provider via a request data structure, said request data structure comprising a request type identifier defining a type for the computer-readable medium, a request identifier, and one or more metadata elements stored with the media content file; and
receiving a return data structure from the metadata provider, said return data structure storing a return type identifier defining the type for the computer-readable medium, the request identifier, and return metadata corresponding to the requested metadata.

38. The media player of claim 37, wherein the instructions further comprise classifying the media content file based on the return metadata.

39. The media player of claim 37, wherein the return data structure comprises a delay time interval, and wherein the instructions further comprise postponing additional requests for metadata until after the delay time interval has elapsed.

40. The media player of claim 37, wherein the instructions further comprise:
associating the return metadata or a portion thereof with namespace identifiers including at least one of WMContentID, WMCollectionID, WMCollectionGroupID; and
storing the namespace identifiers and associated metadata with the media content file.

41. The media player of claim 37, wherein the instructions further comprise classifying the media content using other namespace identifiers including at least one of the following: WMPrimaryClassID and WMSecondaryClassID.

42. The media player of claim 37, wherein the instructions further comprise:
determining an identifier value;
associating the determined identifier value with media content; and
assigning the determined identifier value to one or more of the following namespace identifiers: WMContentID, WMCollectionID, and WMCollectionGroupID; and
storing the identifier value and assigned fields with the media content.

43. A computer-readable medium having stored thereon a data structure representing a request for metadata, said data structure for transmission by a first computing device to a second computing device to request metadata for media content, said data structure comprising:
a request type identifier defining a type for a destination computer-readable medium storing the media content;
a request identifier; and
one or more metadata elements stored with the media content.

44. The computer-readable medium of claim 43, wherein the request type identifier comprises MDQ-CD or MDQ-DVD.

45. The computer-readable medium of claim 43, wherein the type relates to at least one of the following: a compact disc, a digital versatile disc, and flash memory.

46. The computer-readable medium of claim 43, wherein the destination computer-readable medium comprises one or more of the following: a compact disc, a digital versatile disc, and flash memory.

47. A computer-readable medium having stored thereon a data structure sent from a first computing device to a second computing device in response to a request for metadata sent by the second computing device, said data structure comprising:
a return type identifier defining a type for a destination computer-readable medium storing the media content;
a request identifier; and
return metadata corresponding to the requested metadata.

48. The computer-readable medium of claim 47, wherein the request type identifier comprises MDR-CD or MDR-DVD.

49. The computer-readable medium of claim 47, further comprising a delay interval specifying a time period for postponing additional requests for metadata by the second computing device.

50. The computer-readable medium of claim 47, wherein the type relates to at least one of the following: a compact disc, a digital versatile disc, and flash memory.

51. A computer-readable medium having stored thereon a data structure representing a namespace for identifying media content, said data structure comprising:
a first field storing a content identifier value, said first field having a label of WMContentID;
a second field storing a collection identifier value, said second field having a label of WMCollectionID; and
a third field storing a group identifier value, said third field having a label of WMCollectionGroupID.

52. The computer-readable medium of claim 51, wherein said first, second, and third fields represent different levels of granularity for identifying the media content.

53. The computer-readable medium of claim 51, wherein the content identifier value, the collection identifier value, and the group identifier value each comprise a globally unique identifier.

54. The computer-readable medium of claim 51, wherein the third field represents a box set identifier.

55. A computer-readable medium having stored thereon a data structure representing a namespace for classifying media content, said data structure comprising:
a first field storing a primary identifier value, said first field having a label of WMPrimaryClassID; and
a second field storing a secondary identifier value, said second field having a label of WMSecondaryClassID.

56. The computer-readable medium of claim 55, wherein said first and second fields represent different levels of granularity for classifying the media content.

57. The computer-readable medium of claim 55, wherein the primary identifier value and the secondary identifier value each comprise at least one of the following: audio, video, and other.

58. The computer-readable medium of claim 55, wherein the primary identifier value and the secondary identifier value each comprise a globally unique identifier.

59. A computer-readable file storing:
media content;
one or more of the following identifiers characterizing the media content: WMContentID, WMCollectionID, WMCollectionGroupID, WMPrimaryClassID, and WMSecondaryClassID; and
an identifier value associated with each of the one or more identifiers.

60. The computer-readable file of claim 59, wherein the identifier value for WMContentID, WMCollectionID, and WMCollectionGroupID comprises a globally unique identifier.

61. The computer-readable file of claim 59, wherein the identifier value for WMPrimaryClassID and WMSecondaryClassID comprises one of the following: audio, video, or other.

62. The computer-readable file of claim 59, wherein the following identifiers represent increasing levels of granularity for classifying the media content: WMCollectionGroupID, WMCollectionID, and WMContentID.

63. The computer-readable file of claim 59, wherein the following identifiers represent increasing levels of granularity for identifying the media content: WMPrimaryClassID and WMSecondaryClassID.

64. A method for obtaining metadata for media content, said media content being stored on a computer-readable medium, said method comprising:
formulating a network address with a query string parameter, said query string parameter comprising an identifier and a value associated therewith, said identifier or a portion thereof comprising the text string WMID, said associated value corresponding to the media content.

65. The method of claim 64, wherein the formulated network address comprises a uniform resource locator.

66. The method of claim 64, further comprising:
requesting metadata for the media content file from a metadata provider via the formulated network address; and
receiving a return data structure from the metadata provider, said return data structure storing a return type identifier defining a type for the computer-readable medium, a request identifier, and return metadata corresponding to the requested metadata.

67. The method of claim 64, further comprising another query string parameter, said query string parameter comprising another identifier and another value associated therewith, said other identifier comprising one or more of the following: VERSION, LOCALE, and REQUESTID.

68. A method for obtaining metadata for media content, said media content being stored on a computer-readable medium, said method comprising:
formulating a network address with a query string parameter, said query string parameter comprising an identifier and a value associated therewith, said identifier or a portion thereof comprising the text string CD, said associated value corresponding to the media content.

69. The method of claim 68, wherein the formulated network address comprises a uniform resource locator.

70. The method of claim 68, further comprising:
requesting metadata for the media content file from a metadata provider via the formulated network address; and
receiving a return data structure from the metadata provider, said return data structure storing a return type identifier defining a type for the computer-readable medium, a request identifier, and return metadata corresponding to the requested metadata.

71. The method of claim 68, further comprising another query string parameter, said query string parameter comprising another identifier and another value associated therewith, said other identifier comprising one or more of the following: VERSION, LOCALE, and REQUESTID.

72. A method for processing media content, said method comprising:
receiving a request for metadata, said metadata being associated with media content, said request comprising one or more metadata elements;
searching for the requested metadata in a database based on the received metadata elements;
ranking the results of said searching; and
correlating the ranked results with a table to identify the requested metadata.

73. The method of claim 72, wherein searching for the requested metadata comprises searching the database based on the metadata elements collectively.

74. The method of claim 72, wherein ranking the results comprises assigning a weighting to each of the results based on the searching method and received metadata elements.

75. One or more computer-readable media having computer-executable instructions for performing the method of claim 72.
